(19) United States
(12) Patent Application Publication
(10) Pub. No.: US 2015/0259625 A1
(43) Pub. Date: Sep. 17, 2015

(54) DETERGENT COMPOSITION

(71) Applicant: The Procter & Gamble Company, Cincinnati, OH (US)

(72) Inventors: Andrei Sergeevich BUREIKO, Cincinnati, OH (US); Christa Sue PELFREY, Colerain Township, OH (US); Firoj VOHRA, Mason, OH (US)

(21) Appl. No.: 14/645,439

(22) Filed: Mar. 12, 2015

Related U.S. Application Data
(60) Provisional application No. 61/951,584, filed on Mar. 12, 2014.

(51) Int. Cl. C11D 3/50; C11B 9/00; C11D 3/43

(52) U.S. Cl. CPC C11D 3/50; C11D 3/43; C11B 9/0015; C11B 9/0019

(57) ABSTRACT

An alkaline composition comprising an aminoalcohol solvent and a perfume formulation, wherein the perfume formulation comprises at most about 40% per weight of perfume raw materials comprising an ester function, an α,β-unsaturated aldehyde function and/or an α,β-unsaturated ketone function.

### FIELD OF INVENTION

The present application relates to alkaline compositions comprising an aminoalcohol solvent having an improved stability.

### BACKGROUND OF THE INVENTION

Aminoalcohol solvents, and in particular monoethanol amine (MEA) are typically used in many applications such as hair colorant, laundry cleaning composition, or hard surface cleaning composition.

The stability of those compositions is challenging, as the composition are alkaline, sometimes have a high pH, typically comprise a perfume formulation, and may further comprise highly reactive ingredients such as bleach.

The inventors have discovered that the stability issue could be alleviated in alkaline compositions comprising aminoalcohol by selecting a specific perfume formulation.

### SUMMARY OF THE INVENTION

The present application relates to an alkaline composition comprising an aminoalcohol solvent and a perfume formulation, wherein the perfume formulation comprises at most about 40%, per weight of perfume raw materials comprising an ester function, an α,β-unsaturated aldehyde function and/or an α,β-unsaturated ketone function.

The alkaline composition according to the invention has an improved stability.

### DETAILED DESCRIPTION OF THE INVENTION

The Composition

The composition is alkaline. The composition may have a pH between about 7.2 and about 14, or between about 7.5 and about 13.5, or between about 8 and about 13, or between about 8.5 and about 12.5, or between about 9 and about 12, or between about 9.5 and about 11.5, or between about 10 and about 11.

The composition may be a liquid composition.

The composition may have a viscosity at shear rate 10 s⁻¹ of 1 mPa·s or greater, more preferably of from about 1 to about 20.000 mPa·s, or from about 1.5 to about 1000 mPa·s, or from about 2 to about 300 mPa·s, or from about 2.5 to about 100 mPa·s at about 20° C. when measured with a DHR1 rheometer (TA instruments) using a about 2° 40 mm diameter cone/plate geometry, with a shear rate ramp procedure from about 1 to about 1000 s⁻¹.

The composition is typically an aqueous composition and therefore comprises water. The composition may comprise from about 50% to about 98%, or from about 75% to about 97%, or from about 80% to about 97% by weight of water.

The composition may be a laundry composition, for example a laundry composition in a water-soluble unit-dose pouch or a liquid laundry composition in a plastic bottle, or the composition may be a hair colorant or the composition may be a hard surface cleaner composition.

The Aminoalcohol Solvent

The composition comprises an aminoalcohol solvent.

The aminoalcohols may comprise monoethanolamine, monoisopropanolamine and mixtures thereof, most preferably said aminoalcohol comprises monoethanol amine (MEA).

The composition may comprise from about 0.02% to about 30% per weight of aminoalcohol solvent, for example from about 0.05% to about 20%, or from about 0.1% to about 10%, or from about 0.2 to about 5 per weight of aminoalcohol solvent.

The inventors have discovered that the choice of the perfume of the invention was even more critical in the presence of an aminoalcohol solvent such as MEA.

The composition may comprise from about 0.02% to about 30% per weight of monoethanol amine (MEA), for example from about 0.05% to about 20%, or from about 0.1% to about 10%, or from about 0.2% to about 5% per weight of MEA.

Perfume Formulation

The composition comprises a perfume formulation. The perfume formulation is a mixture of odorant perfume raw materials, such as aromatic natural oils and aromatic chemicals, which taken together form a complex scent that delivers a number of benefits. These benefits may include the coverage of product base odor, scenting the product itself, and lingering scent radiating from the surface into the air after treatment. When the composition is sprayed, the benefit may also include the delivery of scent to the air when spraying the composition on a surface, and the delivery of scent to the air while wiping the composition on the surface. The perfume formulation may comprise at least 3, at least 5, at least 7, at least 11, or at least 15 perfume raw materials.

The perfume raw materials of the perfume formulation comprise at most about 40%, or at most about 30%, for example from about 0% to about 20%, or from about 0.01% to about 10%, or from about 0.02% to about 5%, per weight of perfume raw materials comprising an α,β-unsaturated aldehyde function, an α,β-unsaturated ketone function, and/or an ester function.

For the purpose of the invention, an aromatic aldehyde/ketone wherein the aromatic ring is adjacent to the aldehyde or ketone group (e.g. anisic aldehyde or methyl β-naphthyl ketone) is considered as an α,β-unsaturated aldehyde/ketone.

The perfume raw materials of the perfume formulation may comprise at most about 50%, or at most about 40%, or at most about 30% for example from about 0% to about 20%, or from about 0.01% to about 10%, or from about 0.02% to about 5% per weight of perfume raw materials selected from benzyl acetate, methyl salicylate, allyl amyl glycolate, benzyl propionate, pomarose, methyl dihydrojasmonate, heliotropin, anisic aldehyde, delta damascone, amyl butyrate, iso-amyl iso-butyrate, b-ionone, carvone, iso-butyl iso butanoate, methyl b-naphtyl ketone, citronellyl butyrate, iso-propyl miristate.

The inventors have discovered that limiting the percentage of perfume raw materials comprising α,β-unsaturated aldehyde function, an α,β-unsaturated ketone function, and/or an ester function was improving the stability of the composition.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials comprising an α,β-saturated aldehyde function, an α,β-saturated ketone function, an alcohol function, an ether function, a nitrile function, and/or being a terpene.

For the purpose of the invention an α,β-saturated aldehyde function is an aldehyde function without unsaturation in the α or β position.

For the purpose of the invention an α,β-saturated ketone function is a ketone function without unsaturation in the α or β position.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials which do not comprise α,β-unsaturated aldehyde function, an α,β-unsaturated ketone function, and/or an ester function.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials which comprise α,β-saturated aldehyde function, an α,β-saturated ketone function, an alcohol function, an ether function, a nitrile function, and/or are a terpene and which do not comprise an α,β-unsaturated aldehyde function, an α,β-unsaturated ketone function, and/or an ester function.

The perfume raw materials of the perfume formulation may comprise at least about 20% per weight, in particular at least about 30%, or at least about 40%, or at least about 50%, or at least about 60%, or at least about 70% for example from about 80% to about 100%, or from about 90% to about 99.9% per weight of perfume raw materials selected from d-muscenone 1, ambrox, polysantol, phenylethyl dimethyl carbinol, hydroxycitronellal, undecavertol, citronellol, linal0ol, p-cresyl methyl ether, cis-3-hexenol, clonal, limonene, tobacarol 2, tobacarol 3, tobacarol 1, b-naphthyl methyl ether.

The perfume formulation may be comprised in one or more perfume delivery systems. The perfume delivery system may comprise neat perfume, perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof. One or more of the perfume delivery system may comprise the preferred raw perfume material of the invention as defined above. Perfume delivery technologies, methods of making certain perfume delivery technologies and the uses of such perfume delivery technologies are disclosed in US 2007/0275866 A1, US 2004/0110648 A1, US 2004/0092414 A1, 2004/0091445 A1, 2004/0087476 A1, U.S. Pat. Nos. 6,531,444, 6,024,943, 6,042,792, 6,051,540, 4,540,721, and 4,973,422.

When the perfume formulation comprises perfume raw materials, comprising an α,β-unsaturated ketone function, an α,β-unsaturated aldehyde function and/or an ester function, preferably those perfume raw materials are not part of the neat perfume.

The composition may comprise from about 0.01% to about 15%, or from about 0.05% to about 10%, or even from about 0.1% to about 5% or from about 0.2% to about 2%, by weight of a perfume formulation.

Adjunct Materials

For the purposes of the present invention, the non-limiting list of adjuncts illustrated hereinafter are suitable for use in the compositions detailed herein (e.g., consumer products, hair coloring compositions, cleaning and/or treatment compositions, fabric and hard surface cleaning and/or treatment compositions, detergents, and/or a highly compact detergents). Such adjunct materials may be desirably incorporated in certain embodiments of the compositions, for example to assist or enhance performance of the composition, for treatment of the substrate to be cleaned, or to modify the aesthetics of the composition as is the case with perfumes, colorants, dyes or the like. The precise nature of these additional components, and levels of incorporation thereof, will depend on the physical form of the composition and the nature of the operation for which it is to be used.

Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments, metal salts, structurants or binders, anti-tartar agents, anti-caries agents, abrasives, fillers, humectants, breath agents, flavors, antibacterial agents, oxidative hair dyes, hair conditioning materials, additional solvents and alkalizers. In addition to the disclosure below, suitable examples of such other adjuncts and levels of use are found in U.S. Pat. No. 6,326,348 B1.

Each adjunct ingredient is not essential to the composition. Thus, the composition may not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments, metal salts, structurants or binders, anti-tartar agents, anti-caries agents, abrasives, fillers, humectants, breath agents, flavors, antibacterial agents. However, when one or more adjuncts are present, such adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the compositions to about 99.9%, to about 80%, to about 35%, or even to about 30% by weight of the compositions.

Builders—The compositions of the present invention can comprise one or more detergent builders or builder systems. When present, the compositions will typically comprise at least about 1% builder, or from about 5% or 10% to about 80%, about 50%, or even about 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, B-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282. Cobalt bleach catalysts useful herein are known, and are described, for example, in U.S. Pat. No. 5,597,936.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include manganese, iron and chromium. Suitable MRL's herein are a special type of ultra-rigid ligand that is cross-bridged such as 5,12-diethyl-1,5,8,12-tetraazabicyclo[6.6.2]hexa-decane. Suitable transition metal MRLs are readily prepared by known procedures, such as taught for example in and U.S. Pat. No. 6,225,464.

Hair Dyes

The compositions may contain a hair dye which may be selected from those known in the art, e.g. oxidative dye precursors, through which the coloring is produced by the action of oxidizing agents, such as for example hydrogen peroxide, or in the presence of atmospheric oxygen (if necessary with the addition of a suitable enzyme system). The hair dye may be a oxidative dye precursor, a direct dye or a mixture thereof.

The compositions may include oxidative dye precursor in the form of primary intermediates or couplers. The compounds suitable for use in the hair colorant compositions (including those optionally added), in so far as they are bases, may be used as free bases or in the form of their physiologically compatible salts with organic or inorganic acids, such as hydrochloric, hydrobromic, citric, acetic, lactic, succinic, tartaric, or sulfuric acids, or, in so far as they have aromatic hydroxyl groups, in the form of their salts with bases, such as alkali phenolates.

These compounds are well known in the art, and include aromatic diamines, aminophenols, aromatic diols and their derivatives (a representative but not exhaustive list of oxidation dye precursor can be found in Sagarin, “Cosmetic Science and Technology”, “Interscience, Special Edn. Vol. 2 pages 308 to 310). It is to be understood that the precursors detailed below are only by way of example and are not intended to limit the compositions and processes herein. These are: 1,7-Dihydroxynaphthalene (1,7-NAPHTH ALENEDIOL); 1,3-Diaminobenzene (m-PHENYLENEDIAMINE); 1-Methyl-2,5-diaminobenzene (TOLUENE-2,5-DIAMINE); 1,4-Diaminobenzene (p-PHENYLENEDIAMINE); 1,3-Dihydroxybenzene (RESORCINOL); 1,3-Dihydroxy-4-chlorobenzene, (4-CHLORORESORCINOL); 1-Hydroxy-2-aminobenzene, (o-AMINOPHENOL); 1-Hydroxy-3-aminobenzene (m-AMINOPHENOL); 1-Hydroxy-4-amino-benzene (p-AMINOPHENOL); 1-Hydroxynaphthalene (1-NAPHTHOL); 1,5-Dihydroxynaphthalene (1,5-NAPHTHALENEDIOL); 2,7-dihydroxynaphthalene (2,7-NAPHTHELENEDIOL); 1,4-Dihydroxybenzene (HYDROQUINONE); 1-Hydroxy-4-methylaminobenzene (p-METHYLAMINOPHENOL); 6-Hyd[Gamma]oxybenzo-mo[phi]holine (HYDROXYBENZOMORPHOLINE); 1-Methyl-2-hydroxy-4-aminobenzene (4-AMINO-2-HYDROXY-TOLUENE); 1-Methyl-2-hydroxy-4-(2′-hydroxyethyl)aminobenzene (2-METHYL-5-HYDROXY-ETHYLAMINO-PHENOL); 1,2,4-Trihydroxybenzene (1,2,4-TRIHYDROX YBENZENE); 1-Phenol-3-methylpyrazol-5-on (PHENYLMETHYLPYRAZOLONE); 1-(2′-Hydroxyethyloxy)-2,4-diaminobenzene (2,4-DIAMINOPHENOXY-ETHANOL HCL); 1-Hydroxy-3-amino2,4-dichlorobenzene (3-AMINO-2,4-DICHLORO-PHENOL); 1,3-Dihydroxy-2-methylbenzene (2-METHYLRESORCINOL); 1-Amino-4-bis-(2′-hydroxyethyl)aminobenzene (N,N-BIS(2-HYDROXY-ETHYL)-p-PHENYLENE-DIAMINE); 2,4,5,6-Tetraaminopyrimidine (HC Red 16); 1-Hydroxy-3-methyl-4-aminobenzene (4-AMINO-m-CRESOL); 1-Hydroxy-2-amino-5-methylbenzene (6-AMINO-m-CRESOL); 1,3-Bis-(2,4-Diaminophenoxyl)propane (1,3-BIS-(2,4-DIAMINO-PHENOXY)-PROPANE); 1-(2′-Hydroxyethyl)-2,5-diaminobenzene (HYDROXYETHYL-p-PHENYLENE DIAMINE SULPHATE); 1-Methoxy-2-amino-4-(2′-hydroxyethylamino)benzene, (2-AMINO-4-HYDROXYETHYLAMINOANISOLE); 1-Hydroxy-2-methyl-5-amino-6-chlorobenzene (5-AMINO-6-CHLORO-o-CRESOL); 1-Hydroxy-2-amino-6-methylbenzene (6-AMINO-o-CRESOL); 1-(2′-Hydroxyethyl)-amino-3,4-methylenedioxybenzene (HYDROXYETHYL-3,4-METHYLENEDIOXY-ANILINE HCl); 2,6-Dihydroxy-3,4-dimethylpyridine (2,6-DIHYDROXY-3,4-DIMETHYLPYRIDINE); 3,5-Diamino-2,6-dimethoxypyridine (2,6-DIMETHOXY-3.5-PYRIDINEDIAMINE); 5,6-Dihydroxyindole (5,6-DIHYDROXY-INDOLE); 4-Amino-2-aminomethylphenol (2-AMINOETHYL-p-AMINO-PHENOL HCl); 2,4-Diamino-5-methylphenetol (2,4-DIAMINO-5-METHYL-PHENETOLE HCl); 2,4-Diamino-5-(2′-hydroxyethyloxyl)toluene (2,4-DIAMINO-5-METHYLPHENOXYETHANOL HCl); 5-Amino-4-chloro-2-methylphenol (5-AMINO-4-CHLORO-0-CRESOL); 1,3-Bis(N(2-Hydroxyethyl)N(4-amino-phenyl)amino)-2-propanol (HYDROXYPROPYL-BIS-(N-HYDROXY-ETHYL-p-PHENYLENEDIAMINE)HCL); 6-Hydorxyindole (6-HYDROXY-INDOLE); 2,3-Indolinedione (ISATIN); 3-Amino-2-methylamino-6-methoxypyridine (HC BLUE NO. 7); 1-Phenyl-3-methyl-5-pyrazolone (2,4-DIHYDRO-5-METHYL-2-PHENYL-3H-PYRAZOL-3-ONE); 2-Amino-3-hydroxypyridine (2-AMINO-3-HYDROXYPYRIDINE); 5-Amino-salicylic acid; 1-Methyl-2,6-bis(2-hydroxy-ethylamino)benzene (2,6-HYDROXYETH YLAMINO-TOLUENE); 4-Hydroxy-2,5,6-triaminopyrimidine (2,5,6-TRIAMINO-4-PYRIMIDINOL SULPHATE); 2,2′-[1,2-Ethanediyl-bis-(oxy-2,1-ethanediyloxy)]-bis-benzene-1,4-diamine (PEG-3,2′,2′-DI-p-PHENYLENEDI AMINE); 5,6-Dihydroxyindoline (DIHYDROXYINDOLINE); N,N-Dimethyl-3-ureidoaniline (m-DIMETHYL-AMINO-PHENYLUREA); 2,4-Diamino-5-nuortoluenesulfatehydrate (4-FLUORO-6-METHYL-m-PHENYLENEDIAMINE SULPHATE); 1-Acetoxy-2-methylnaphthalene (1-HYDROXY YETHYL-4,5-DIAMINOPYR AZOLE SULPHATE); 1-acetoxy-2-methylnaphthalene (2-METHYL-1-NAPHTHOL); 2-amino-5-ethylphenol (2-AMINO-5-ETHYLPHENOL); 2,4-dichloro-3-aminophenol (3-AMINO-2.4-DICHLOROPHENOL); and p-Aniline-aniline (N-PHENYL-P-PHENYLENEDIAMINE).

The hair colorant compositions may also comprise compatible direct dyes, in an amount sufficient to provide coloring, particularly with regard to intensity. Typically, such an amount will range from about 0.05% to about 4%, by weight of the hair colorant composition of a subcomponent such as a tint composition.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example A

### Stability of Perfume Component in an Alkaline Composition Comprising MEA at a pH Around 11

| | | Half- | Half- |
|---|---|---|---|
| | | life, | life, |
| | | days | days, |
| | | at room | at 49 |
| | | temper- | degree |
| Perfume raw material | nature | ature | C. |
| benzyl acetate | ester | 0 | 0 |
| methyl salicylate | ester | 0 | 0 |
| allyl amyl glycolate | ester | 0 | |
| benzyl propionate | ester | 1 | 0 |
| pomarose | α, β-unsaturated ketone | 1 | 0 |
| methyl | ester | 1 | 0 |
| dihydrojasmonate | | | |
| heliotropin | α, β-unsaturated aldehyde | 6 | 5 |
| anisic aldehyde | α, β-unsaturated aldehyde | 6 | |
| delta damascone | α, β-unsaturated ketone | 7 | 0 |
| amyl butyrate | ester | 12 | 3 |
| iso-amyl iso-butyrate | ester | 17 | 4 |
| b-ionone | α, β-unsaturated ketone | 19 | 7 |
| carvone | α, β-unsaturated ketone | 19 | stable |
| iso-butyl iso-butanoate | ester | 20 | 5 |
| methyl b-naphthyl ketone | α, β-unsaturated aldehyde | 45 | 19 |
| citronellyl butyrate | ester | stable | 11 |
| iso-propyl | ester | stable | 25 |
| miristate (IPM) | | | |
| d-muscenone 2 | α, β-saturated ketone | stable | 29 |
| linalyl iso-butyrate | ester | stable | 36 |
| b-naphthyl methyl ether | ether | stable | 39 |
| tobacarol 1 | ether | stable | stable |
| tobacarol 3 | ether | stable | 45 |
| tobacarol 2 | ether | stable | 47 |
| limonene | terpene | stable | 47 |
| clonal | nitrile | stable | stable |
| cis-3-hexenol | alcohol | stable | stable |
| p-cresyl methyl ether | ether | stable | stable |
| linalool | alcohol | stable | stable |
| citronellol | alcohol | stable | stable |
| undecavertol | alcohol | stable | stable |
| hydroxycitronellal | α, β-saturated aldehyde | stable | stable |
| phenyl ethyl | alcohol | stable | stable |
| dimethyl carbinol | | | |
| polysantol | alcohol | stable | stable |
| ambrox | ether | stable | stable |
| d-muscenone 1 | α, β-saturated ketone | stable | stable |

### Example 1-6

### Hard Surface Cleaners Compositions

Examples 1 to 6 are hard surface cleaner compositions. Those compositions are stable, provide good cleaning performance, good shine to the surface and preserve the surface safety of the surface to be cleaned.

Compositions of examples 1-4 are sprayable compositions suitable to clean hard surfaces. Composition 5 and 6 are concentrated compositions which are typically diluted about 15 times before being used, for example in a spray.

The compositions 1-6 are prepared by mixing the ingredients.

| | weight percentage | | | | | |
|---|---|---|---|---|---|---|
| | example | example | example | example | example | example |
| Ingredient | 1 | 2 | 3 | 4 | 5 | 6 |
| Amine oxide | 0.5 | 0.5 | 0.4 | 0.7 | 7.5 | 7.5 |
| Nonionic surfactant | 0.1 | 0.1 | 0.05 | 0.2 | 1.5 | 1.5 |
| Sodium carbonate | 0.1 | 0.1 | 0.2 | 0.05 | 1.5 | 1.5 |
| MEA (1) | 0.5 | 0.5 | 0.7 | 0.4 | 7.5 | 7.5 |
| Perfume Formulation | 0.3 | 0.2 | 0.1 | 0.05 | 3 | 3 |
| (2) | | | | | | |
| Antimicrobial agent | | 0.1 | | 0.2 | | 1.5 |
| Preservative | 0.01 | | 0.02 | | 0.15 | |
| dye | 0.001 | 0.01 | 0.0001 | 0.002 | 0.015 | 0.015 |
| water | qsp | qsp | qsp | qsp | qsp | qsp |

(1) Mitsui Chemicals Inc./Monoethanolamine
(2) Perfume formulation comprising a low percentage of ester, α, β-unsaturated aldehyde, and α, β-unsaturated ketone

### Example 7 (A-C)

### Oxidative Hair Colorant Tint Compositions

| | A | B | C |
|---|---|---|---|
| SHADE | Red | Light | Black |
| | | Golden | |
| | | Brown | |
| Component | % by | % by | % by |
| | weight | weight | weight |
| | of tint | of tint | of tint |
| | compo- | compo- | compo- |
| | sition | sition | sition |
| Ethoxydiglycol | 13 | 10 | 15 |
| Propylene glycol | 5 | 5 | 5 |
| Sodium Hydroxide | 0.34 | 0.6 | |
| Erythorbic Acid | 0.3 | 0.3 | 0.3 |
| Ethylene Diamine Tetraacetic Acid - | 0.1 | 0.1 | 0.1 |
| EDTA | | | |
| Sodium sulfite | 0.1 | 0.1 | 0.1 |
| Citric acid Anhydrous | 0.6 | 0.6 | 0.6 |
| Isopropyl Alcohol | 5 | 4 | 4.5 |
| Monoethanolamine (1) | 5.5 | 5.5 | 4.5 |
| Sodium Lauryl Sulfate | 0.5 | 0.6 | 0.7 |
| Cocoamidopropyl Betaine | 0.5 | 0.5 | 0.6 |
| Perfume (2) | 0.6 | 1 | 1.5 |
| m-Aminophenol | — | 0.129 | — |
| 1-Naphthol | 0.1 | — | — |
| 1,4-Diamino-2-(methoxymethyl)-benzene | 1.5 | 0.686 | 3 |
| Resorcinol | — | 0.266 | 0.7 |
| P-Aminophenol | — | 0.683 | 0.4 |
| 2-Methylresorcinol | — | 0.547 | — |
| 4-Amino-2-Hydroxytoluene | 1 | 0.124 | — |
| 1-Hydroxyethyl | 1.5 | — | 0.06 |
| 4,5-Diamino Pyrazole Sulfate | | | |
| Phenyl Methyl Pyrazolone | 0.125 | 0.059 | — |
| 2-Methyl-5-Hydroxyethylaminophenol | 0.7 | — | — |
| PAOX | | | |
| 2-Amino-4-Hydroxyethylaminoanisole | — | 0.025 | 0.9 |
| Sulfate | | | |
| Hydroxyethyl-3,4-Methylenedioxyaniline | 0.8 | — | — |
| HCl | | | |
| Water | to 100% | to 100% | to 100% |

(1) Supplied by Huntsman Corporation
(2) Perfume formulation comprising a low percentage of ester, α, β-unsaturated aldehyde, and α, β-unsaturated ketone

The compositions of the Examples 7 (A-C) may be mixed in a 1:1 weight ratio with a developer composition comprising a solution of hydrogen peroxide (4.5% w/w) in water to form an oxidative hair colorant mixture. The resulting mixture may be introduced into a foamer container and dispensed as hair coloring foam of acceptable quality.

### Examples 8

### Unit Dose Composition

| Ingredient | percent |
|---|---|
| C14-C15 alkyl poly ethoxylate | 12.5 |
| C12-C14 alkyl poly ethoxylate | 1.5 |
| C12-C14 alkyl poly ethoxylate, sulfate Mono | 8.8 |
| EthanolAmine salt | |
| Linear Alkylbenzene sulfonic acid | 18 |
| Citric Acid | 0.6 |
| C12-C18 Fatty Acid | 6 |
| Enzymes | 1.5 |
| PEI 600 EO20 | 4 |
| Diethylene triamine penta methylene | 2 |
| phosphonic acid or HEDP | |
| Fluorescent brightener | 0.3 |
| Hydrogenated Castor Oil | 0.2 |
| 1,2 propanediol | 16 |
| Glycerol | 5.5 |
| Mono Ethanol Amine (1) | 8 |
| Dye | Present |
| Potassium sulphite | 0.3 |
| Perfume (2) | 1 |
| Water | qsp |

(1) Mitsui Chemicals Inc./Monoethanolamine
(2) Perfume formulation comprising a low percentage of ester, α, β-unsaturated aldehyde, and α, β-unsaturated ketone

### Example 9-10

### Heavy Duty Liquid Laundry Detergent Compositions

| | 9 | 10 |
|---|---|---|
| Ingredient | (wt %) | (wt %) |
| AES C₁₂₋₁₅ alkyl ethoxy (1.8) | 10 | 6.32 |
| sulfate | | |
| Linear alkyl benzene | 4 | 3.3 |
| sulfonate/sulfonic acid | | |
| HSAS | 5.1 | 0 |
| Sodium formate | 0.09 | 0.04 |
| Sodium hydroxide | 3.8 | 1.9 |
| Monoethanolamine (1) | 1.49 | 0.7 |
| AE9 | 0.6 | 0.3 |
| Chelant (HEDP) | 0.15 | 0.07 |
| Citric Acid | 3.96 | 1.98 |
| C₁₂₋₁₄ dimethyl Amine Oxide | 0.73 | 0.37 |
| C₁₂₋₁₈ Fatty Acid | 1.9 | 0.99 |
| Borax | 1.5 | 0.75 |
| Ethanol | 1.77 | 0.89 |
| Ethoxylated (EO₁₅) tetraethylene | 0.33 | 0.17 |
| pentamine | | |
| Ethoxylated hexamethylene | 0.81 | 0.4 |
| diamine | | |
| 1,2-Propanediol | 6.6 | 3.3 |
| Fluorescent Brightener | 0.1 | 0.3 |
| Perfume (2) | 1.8 | 0.8 |
| Enzymes | 0.8 | 1.2 |
| *Water, dyes & minors | qsp | qsp |

(1) Mitsui Chemicals Inc./Monoethanolamine
(2) Perfume formulation comprising a low percentage of ester, α, β-unsaturated aldehyde, and α, β-unsaturated ketone

### Example 11

### Perfume Composition According to the Invention

| | Wet | |
|---|---|---|
| Raw Material Name | % | Nature* |
| Methyl Beta-Naphthyl Ketone | 0.2 | α, β-unsaturated ketone |
| Methyl Dihydro Jasmonate | 4 | ester |
| Methyl Iso Butenyl Tetrahydro | 0.8 | ether |
| Pyran | | |
| Methyl Nonyl Acetaldehyde | 1 | α, β-saturated aldehyde |
| Nonyl Aldehyde | 0.5 | α, β-saturated aldehyde |
| Octyl Aldehyde | 2 | α, β-saturated aldehyde |
| Para Cymene | 3 | terpene |
| Terpineol | 2 | terpene |
| Terpineolene | 7 | terpene |
| Alpha Pinene | 4 | terpene |
| Beta Pinene | 2 | terpene |
| Camphene | 2 | terpene |
| Citral | 3 | α, β-unsaturated |
| | | aldehyde |
| Citronellol | 3 | alcohol |
| Citronellyl Nitrile | 6 | nitrile |
| Decyl Aldehyde | 2 | α, β-saturated aldehyde |
| Dihydro Myrcenol | 3 | alcohol |
| Dipropylene Glycol | 7 | ether |
| Eucalyptol | 2 | ether |
| Geraniol | 3 | alcohol |
| Geranyl Acetate | 3 | ester |
| Hexyl Cinnamic Aldehyde | 4 | α, β-unsaturated |
| | | aldehyde |
| Hydroxycitronellal | 1 | α, β-saturated aldehyde |
| Iso Bornyl Acetate | 2 | ester |
| Italian Orange Phase Oil #11120 | 16 | mostly terpene |
| Lemon C.P. | 3 | mostly terpene |
| Ligustral Or Triplal | 0.1 | α, β-saturated aldehyde |
| Limettene/Terpineol Mix (50/50) | 3 | mostly terpene |
| Etc | | |
| Linalool | 7 | alcohol |
| Linalyl Acetate | 3 | α, β-unsaturated |
| | | aldehyde |

*in this example, when the perfume raw material comprises more than one function, the priority has been given to the ester, aldehyde ketone functions and then to the terpene function.

This composition comprises about 90% of perfume raw material which do not comprise any ester function, any α,β-unsaturated aldehyde function and/or any α,β-unsaturated ketone function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An alkaline composition comprising an aminoalcohol solvent and a perfume formulation, wherein the perfume formulation comprises at most about 40% per weight of perfume raw materials comprising an ester function, an α,β-unsaturated aldehyde function and/or an α,β-unsaturated ketone function.

2. The composition according to claim 1, wherein the perfume formulation comprises at most 20% per weight of perfume raw materials comprising an ester function, an α,β-unsaturated aldehyde function and/or an α,β-unsaturated ketone function.

3. The composition according to claim 1, wherein the composition is an liquid aqueous composition.

4. The composition according to claim 1, wherein the composition has a pH between about 7.5 and about 13, preferably between about 8 and about 12.

5. The composition according to claim 1 wherein the aminoalcohol solvent comprises monoethanolamine.

6. The composition according to claim 1 comprising at least about 0.2% or about 10% by weight of monoethanolamine

7. The composition according to claim 1 being a laundry cleaning composition, a hard surface cleaner composition, or a hair colorant composition.
